(19) United States
(12) Patent Application Publication
(10) Pub. No.: US 2025/0200090 A1
(43) Pub. Date: Jun. 19, 2025

(54) INTELLIGENT USER RESEARCH ASSISTANT

(71) Applicants: Joerg BERINGER, Los Altos, CA (US); Thomas GEIS, Cologne (DE); Jan HARMSEN, Cologne (DE); Joris BERINGER, Frankfurt am Main (DE)

(72) Inventors: Joerg BERINGER, Los Altos, CA (US); Thomas GEIS, Cologne (DE); Jan HARMSEN, Cologne (DE); Joris BERINGER, Frankfurt am Main (DE)

(21) Appl. No.: 18/988,869

(22) Filed: Dec. 19, 2024

Related U.S. Application Data
(60) Provisional application No. 63/612,173, filed on Dec. 19, 2023.

(51) Int. Cl. G06F 16/334; G06F 16/36; G06F 16/901

(52) U.S. Cl. CPC G06F 16/3344; G06F 16/367; G06F 16/9024

(57) ABSTRACT

A system performs automatic context graph generation based on LLM (large language model) queries. The system submits a user query to the LLM based on an ontology for a context of the user query. The system parses a response from the LLM system to automatically identify a context graph node from the response based on the ontology. The system automatically builds the context graph based on the identified node, and builds out the context graph by iteratively submitting subsequent queries and parsing out sub-nodes from subsequent responses. Repeating the submitting of LLM prompts and identifying child nodes from the LLM output based on the identified ontology builds out the graph until boundary conditions are met. The system builds out the graph with an accumulated context represented in the form of the existing nodes.

### FIELD

Descriptions are generally related to LLMs (large language models), and more particular descriptions are related to querying LLMs.

### BACKGROUND

When developing products or evaluating the use of products, it is good practice to develop a deep understanding of the context in which a product is used, referred to as the “Context of Use”. A Context of Use consists of all important aspects which describe what users want to achieve with a product or service and how the product/service can help them to achieve the desired outcomes.

Putting together the Content of Use into a workable model tends to involve significant expense for activities related to user research. The research includes observing users and interviewing individuals to generate the needed information from credible sources. However, access to individuals can be limited, and site visits are expensive and time-consuming, while remote interviewing tends to lack detail and realism.

Even when information can be gathered, it is unstructured, which is difficult to document and synthesize into comprehensive information from which a model can be built. The accumulation of knowledge, while broadening the knowledge base, tends to rely more heavily on fewer individuals that understand how to structure the information. Additionally, research may lead to duplication of efforts and duplication of information, which can tend to increase the difficulty and time needed to organize the information into a usable model.

With the emergence of LLMs (large language models) and NLP (natural language processing) chat interfaces, the business community would like to leverage LLMs as a source for knowledge acquisition about anything. By definition, LLMs are a great source for gathering information about a certain domain related to a product, but the suitability of prompt interfaces of LLM chat interfaces is limited to providing interesting snippets of information without any coherent organization from the perspective of user requirements.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1A-1B are block diagrams of an example of a context of use model generator.

FIG. 2 is a block diagram of an example of a model for context description.

FIG. 3 is a block diagram of an example of a system to generate a context of use model.

FIG. 4 is a diagram of an example of a user interface.

FIG. 5 is a diagram of an example of a context graph output process.

FIG. 6A is a block diagram of an example of a use case specification.

FIG. 6B is a block diagram of an example of a task description for a context graph.

FIG. 6C is a block diagram of an example of a product context analysis.

FIG. 7 is a block diagram of an example of a context graph browser.

FIG. 8 is a block diagram of an example of a context graph browser context creator.

FIG. 9 is a block diagram of an example of a context graph browser stakeholder output list.

FIG. 10 is a block diagram of an example of a context graph browser user story output.

FIG. 11 is a block diagram of an example of a context graph browser opportunities output.

FIG. 12 is a flow diagram of an example of a process for generating a context graph.

FIG. 13 is a block diagram of an example of a computing system in which context use modeling can be performed.

Descriptions of certain details and implementations follow, including non-limiting descriptions of the figures, which may depict some or all examples, and well as other potential implementations.

### DETAILED DESCRIPTION

As described herein, a system performs automatic context graph generation based on LLM (large language model) queries. The system submits a user query to the LLM. The user query can have a context associated with it. The system can map the user query to an ontology. The system parses a response from the LLM system to automatically identify a context graph node from the response based on the ontology. The system automatically builds the context graph based on the identified node, and builds out the context graph by iteratively submitting subsequent queries and parsing out sub-nodes from subsequent responses. Repeating the submitting of LLM prompts and identifying child nodes from the LLM output based on the identified ontology builds out the graph until boundary conditions are met. The system builds out the graph with an accumulated context represented in the form of the existing nodes.

The system identifies an ontology for an initial user input and determines a base node for the ontology from the user query. The system then generates and enriches the knowledge graph exclusively via an automated prompt pipeline using LLM as a synthetic knowledge repository. Such prompts not only query the next level children based on the ontology, but also based on the already accumulated context represented in form of the parent nodes already populated in the graph. Thus, the system parses the LLM output and generates subsequent prompts to make sure the output of the LLM fits the current context.

Thus, the system uses LLM output recursively to generate and detail out a knowledge graph. The system can generate the knowledge graph without needing further user input. In one example, a user can modify the results. Even when a user modifies the results, the modification does not intervene with the first automatic generation of the knowledge graph by the system.

An intelligent user research assistant as described herein generates detailed context descriptions and user requirements for a user-defined high-level description for a leading context of use, or an existing or to-be-built product solution. A system provides an intelligent co-authoring environment for generating the context of use descriptions, where the user enters minimal input to set the focus, and the system automatically generates a detailed context description related to the initial focus. The detailed context description includes facets of the context of use. In one example, the system generates a detailed context description having all facets related to the ontology definition.

In one example, the user interacts with the generated context to explore, refine, augment the generated context graph, or a combination. In one example, the system can output user requirement documents for a user-defined part of the context graph based on user input. The system optionally enables the user to perform what-if analyses with different points of view or assumptions about a solution.

The user can provide a short description of a core task or a process as the initial prompt. In one example, the user optionally provides information including one or more of the circumstances of doing the task, the acting user role, and the envisioned product solution. In one example, the system includes an autonomous context graph (CG) engine that enriches the initial user input by recursively using the context stored in the knowledge graph to generate prompts that query the LLM system for more detailed information. The CG engine can use the output from the LLM system to enrich each node with metadata and related child entities along a hierarchical task structure.

In one example, the system provides an interactive co-authoring environment to the researcher. In the interactive environment, the user can explore and modify the generated context graph. In one example, the user can initiate generation of the knowledge graph, or the user can reinitiate the generation of the knowledge graph from a selected node in the graph.

In one example, the CG engine automatically produces industry-standard requirement statements from high-level use input, by identifying user needs that reflect prerequisites to performing the specified task and subtasks and translating the needs into natural language requirements phrases. The requirements phase can identify language that conforms with industry standards. In one example, the user can output those requirements for a selected part of the context graph. In one example, the CG engine persists the knowledge graph to be reused by the user for further context analysis or generating reports.

In one example, the system provides enterprise accounts to represent the overall context of use across a product portfolio. The system can share the persisted context graphs within an enterprise account, where each context graph is vectorized to make the graph semantically searchable and comparable, indexed per enterprise tenant. In one example, each new user request for generating a context graph is compared with already existing context graphs of the same tenant. In the case of semantic proximity or overlap, the system can offer stakeholder to reuse, merge the context graphs, and analyze the portfolio, having been notified about the overlaps.

While there are educational programs for UX (user experience) professionals to use the concept of a context of use description, no program explains the generation of user stories or advanced requirements specifications from a context of use description. In contrast, a system as described herein can generate context graphs from context of use information.

Knowledge graphs are used to represent structured information like ERP (enterprise resource planning) databases that exist outside of the LLM. The system described herein generates the knowledge graph based on a predefined meta model (the context of use model) and then applies an LLM system to populate the model incrementally. The process of building out the model is controlled by flow logic that uses the information returned by the LLM to dynamically create the next prompts and traverse the entire task hierarchy and related nodes in the graph.

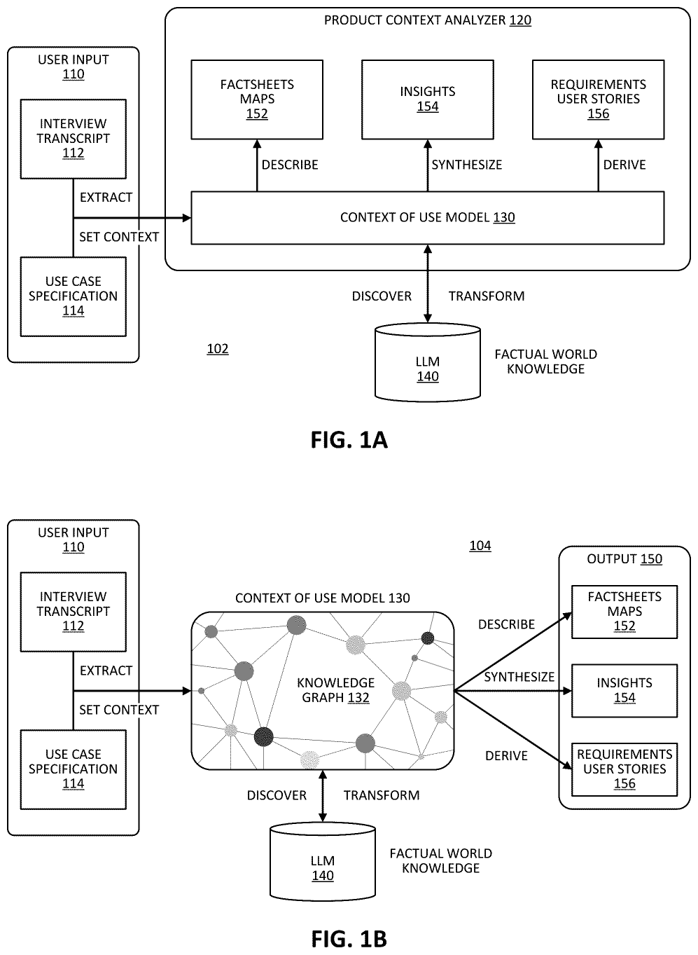

FIGS. 1A-1B are block diagrams of an example of a context of use model generator. System 102 represents a context graph generator system. System 102 illustrates user input 110, which provides input to product context analyzer 120. User input 110 provides the initial query received from the user. Product context analyzer 120 represents the system that determines the context for the user query, and iteratively queries the LLM, parses the responses, and builds the context graph.

When conducting contextual inquiry or field studies that include observing a user at the workplace and asking questions about their performance, the goal is to understand the entire context of a user to observe current work practice. The system can discover underserved user needs related to an existing or new product.

While such qualitative user interviews are a widely accepted research method, there is not much information available on how to synthesize the results and end up with a consolidated user research report. In contrast to quantitative research like usability testing or A/B comparison, qualitative research does not produce any metrics that can be collected and averaged. Instead, the researcher ends up with a narrative transcript for each contextual interview. To consolidate unstructured transcripts, the system can convert them into structured information.

One variant of modeling the full context of a user's reality is the concept of use model. Like contextual design, a concept of use model defines a set of UX related concepts as the constituents of a solution's edge reality when being used by users. These are user profiles, task and sub tasks, task object, resources, pain points, and goals. A context of use model lists all identified entities and models the relationships between the entities. For example, a [user] is performing a [task] which has a [goal].

The context of use model combines the different aspects of work modeling into one single graph which is factual description of the as-is work practice. The graph information serves as a foundation to describe the problem space without summarizing or drawing conclusions about design directions. Classic design thinking artifacts like personas or journey maps can be constructed from the foundation model.

System 102 includes user input 110, where interview transcript 112 represents a written input query from the user. Use case specification 114 represents a specification of a context of use, providing the boundaries based on an ontology. The system can extract information from the query and set the context to use for LLM queries.

In one example, product context analyzer 120 applies model 130, which represents a context of use model as the underlying foundational model to capture the use-related reality of a solution (the “What”). Model 130 queries information from LLM 140, which represents factual world knowledge in LLM repositories. Model 130 sources or discovers information from LLM repositories that represent world knowledge about the selected domain. Product context analyzer 120 transforms the knowledge of the LLM into model 130.

The model provides a foundation, which product context analyzer 120 can then use to comprehend the information into special purposed models such as personas, task models, jobs-to-be-done maps, describe insights, and user requirements or user stories (the “So-What”). System 102 illustrates that model 130 can provide factsheets maps 152 as a description of the generated model. Model 130 can synthesize information for the user, as represented by insights 154. Model 130 can derive requirements and user stories 156 from the model.

System 104 illustrates a system in accordance with an example of system 102. System 104 illustrates user input 110, and represents factsheets maps 152, insights 154, and requirements and user stories 156 as output 150. Output 150 is the output of model 130. System 104 specifically illustrates model 130 as knowledge graph 132, with connections of nodes that represent the knowledge for a context of the query.

To create a context of use description, the researcher only needs to specify a human-centered use case which the solution is supposed to support. For example, a user can generate a query such as: “[a specific user] performs [a specific task] in [a specific situation]”. From such an input, which is aligned with the definition of usability, in one example, product context analyzer 120 generates an interactive knowledge graph 132 representing the context of use. The interactive knowledge graph provides an interactive analytical view of the data. The generated graph can be explored by researchers to understand the “What”. On top of the foundational context of use model 130, product context analyzer 120 offers additional content such as 360-degree factsheets, summary models, and derived user requirements or user stories that can be accessed as needed.

In one example, product context analyzer 120 implements a stakeholder requirements approach, where user groups other than the primary user are identified together with their user needs and relationships to a solution. The stakeholder requirements approach expands the context analysis to all stakeholders and helps the researcher to understand the larger stakeholder network to pursue untapped opportunities of expanding the footprint of a solution.

In one example, the system (e.g., system 102, system 104) can derive other insights from the core context mode, such as a job-to-be-done analysis listing the desired outcomes related to the product context, key issues to be addressed, a list of task objects the stakeholders are interacting with, or other outcomes, or a combination of these.

In one example, the system provides different types of context of use model.

In one example, the model type has a task-centric concept of a journey, which represents a multiphase process which spans across different settings in time or location, and which requires multiple user groups to perform different tasks to fulfill the goals of each phase.

In one example, the model type has a task-centric concept of a phase, which represents a milestone or state of a larger journey which is focused on reaching specific goals or condition before proceeding to the next phase or before declaring a journey as accomplished.

In one example, the model type has a task-centric concept of a responsibility, which represents an ongoing ownership of pursuing an intended outcome which cannot be directly executed but requires a bundle of related tasks whose outcome is contributing to the goals of a responsibility.

In one example, the model type has a task-centric concept of a task, which represents an activity undertaken in order to achieve a meaningful outcome.

In one example, the model type has a task-centric concept of a sub-task, which represents most tasks can be sub-divided into sub-tasks. A sub-task does not in itself achieve a goal from the user's point of view but is a necessary phase to reach the goal.

In one example, the model has an outcome related concept of a goal, which represents the intended outcome expressed as the state or condition that should be achieved. Goals are not always task-related but can also refer to personal or business-related goals.

In one example, the model has an outcome related concept of a pain point, which represents a dissatisfaction perceived by a stakeholder when trying to reach a goal.

In one example, the model has an object-centric concept of a task object, which represents the objects that are created, modified, or inspected by a person to achieve the intended outcome(s) of a task.

In one example, the model has an object-centric concept of a resource, which represents all means required to perform an activity.

In one example, the model has a user-centric concept of a stakeholder, which represents a user group or an organization with an interest in the solution context, for example a job profile (Sales Rep), a persona (the customer), or the sales department.

In one example, the model has a user-centric concept of a user, which represents the stakeholders who interact either directly (primary user) or indirectly (Indirect user) with the interactive system or its output or are indirectly affected by its output (affected user).

In one example, the system provides different types of special-purpose views.

In one example, the model view has a view concept of a 360 factsheet, which represents a filtered list into the product context, listing all information which is related to a selected entity, for example everything which related to a selected stakeholder or a selected task.

In one example, the model view has a view concept of a journey map, which represents a tabular overview of a journey, listing all phases of a process with their contributing stakeholders, tasks to be performed, goals and pain points.

In one example, the model view has a view concept of an object map, which represents a tabular overview of all task objects and resources related to a task or sub-task. Such a table can provide the user with an idea of what objects are being manipulated during the supported activity.

In one example, the model view has a view concept of a job-to-be-done map, which represents a tabular view listing the desired outcomes of the task and each of its sub-tasks. Such a table can provide the user with a framework to formulate human-centered design objects and rate design according to the metrics defined by the outcome statements.

In one example, the system provides different types of derived requirements.

In one example, the derived requirements have a requirements concept of an as-is context scenario, which represents a short narrative illustrating in an authentic way how a user is performing a specific task. Such story telling should help users to understand the complete user context specific to a task.

In one example, the derived requirements have a requirements concept of a user requirement, which represents a statement specifying a requirement a solution design must fulfill to meet a user need related to performing a task.

In one example, the derived requirements have a requirements concept of a user story, which represents a statement specifying a to-be-implemented system operation or function which a system design must support in order to enable the user to successfully perform a task.

In one example, the system provides different types of insights.

In one example, the model has an insight concept of an affinity model with key issues, which represents large areas and subthemes representing the key issues identified in the context of use. Original pain points can be listed under each subtheme and can be used to navigate to the corresponding context.

In one example, the model has an insight concept of an affinity model with design objectives, which represent large areas and subthemes representing key human-centered qualities which the design should optimize. The original outcome statements can be listed under each subtheme and can be used to navigate to the corresponding context.

In one example, the system can determine from the ontology which actors are in charge of tasks. In one example, the ontology indicates who performs a task, who contributes to a task, who is affected by the task, who has to authorize the task, and so forth, enabling the system to automatically identify actors associated with tasks of the sub-nodes.

In one example, the system can identify goals or intended outcomes associated with a context graph. The goals can be task-related goals or business-related goals. The system can present the information as an interactive report. An interactive report refers to a report the user can interact with, selecting information in the report to generate different lists and different views of information. Not only can the system identify responsibilities associated with tasks, but subtasks of the tasks, what skill sets are needed for certain tasks, and other information to provide the knowledge graph to enable a user to set a plan to execute on the query.

It will be understood that once the graph is built, the system no longer need to query the LLM, but simply pull and process the information into knowledge reports and present the information to a user. The system can analyze the data and create different views, enabling the user to get value out of the data received.

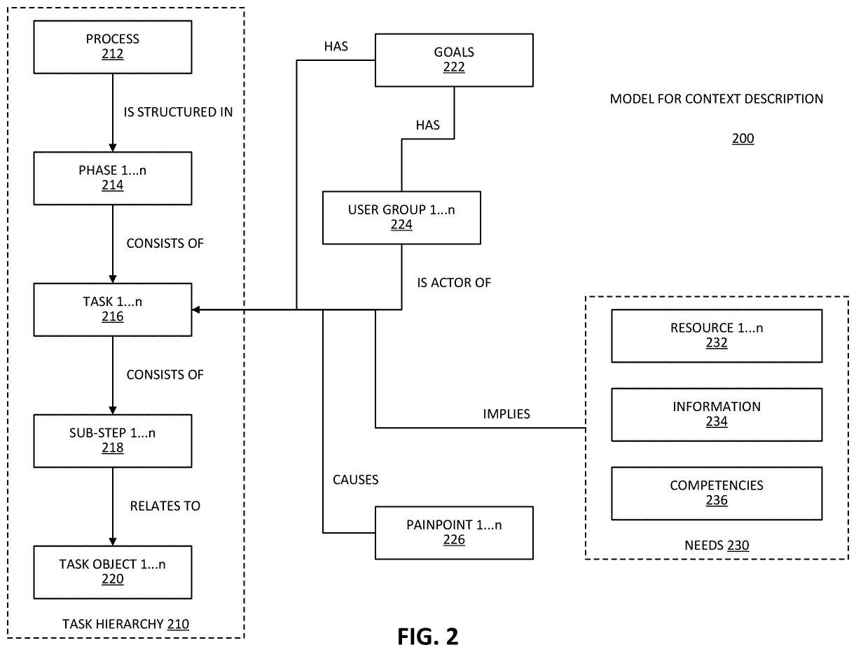

FIG. 2 is a block diagram of an example of a model for context description. Model 200 represents an example of a model for a context description in accordance with an example of system 102 or an example of system 104. Model 200 can be a model used by the system to generate a context graph. In the graph, the notation 1 . . . n indicates one or more, and the number n is not necessarily the same for the different components of model 200.

As illustrated, model 200 includes task hierarchy 210. Task hierarchy 210 represents the tasks to be performed to achieve the desired outcomes. Task hierarchy 210 includes process 212, which represents something that needs to be done. Process 212 can be structured in phases 214. Phases 214 represent one or more phases of operation/execution. Phases 214 consist of tasks 216, which represent one or more tasks/operations to be performed to achieve the desired outcomes.

In one example, one or more of tasks 216 consists of one or more sub-step or sub-tasks, represented by sub-steps 218. The sub-tasks represent the individual units of execution to complete process 212. In one example, individual units of execution relate to one or more task objects 220. Task objects 220 represent the resources needed to perform some task to complete process 212.

Goals 222 represent the goals people have in terms of personal development, business outcomes, or results of tasks, and they represent the desired outcomes for model 200. Goals 222 can have one or more user groups 224. User groups 224 represent the stakeholders. The stakeholders are the actors for tasks 216, which can be the direct users of the product, as well as other people who are affected by or interested in the outcomes of the product.

In one example, user groups 224 imply one or more needs 230. Needs 230 can include one or more resources 232, information 234, and competencies 236. Needs 230 specifically represent the needs for specific roles identified by user groups 224. Thus, while resources 232 represent resources for a stakeholder role of user groups 224, task objects 220 represent resources for performing tasks.

Information 234 can represent the knowledge base needed for a particular role as well as the knowledge that needs to be provided to a specific user role. Competencies 236 represent the skills needed to perform a user role. In one example, model 200 can indicate one or more painpoints 226. Painpoints 226 represent difficulties in the implementation of tasks.

Model 200 exists within an environment, which is the physical and socio-technical environment in which a product is used. The ontology of model 200 is associated with the environment. Based on the environment of model 200, providing a context of use, UX professionals can create artifacts such as user personas, journey maps, task models, process diagrams, and so forth. The UX professionals can share the artifacts with product development teams to guide the ideation and design of the product features.

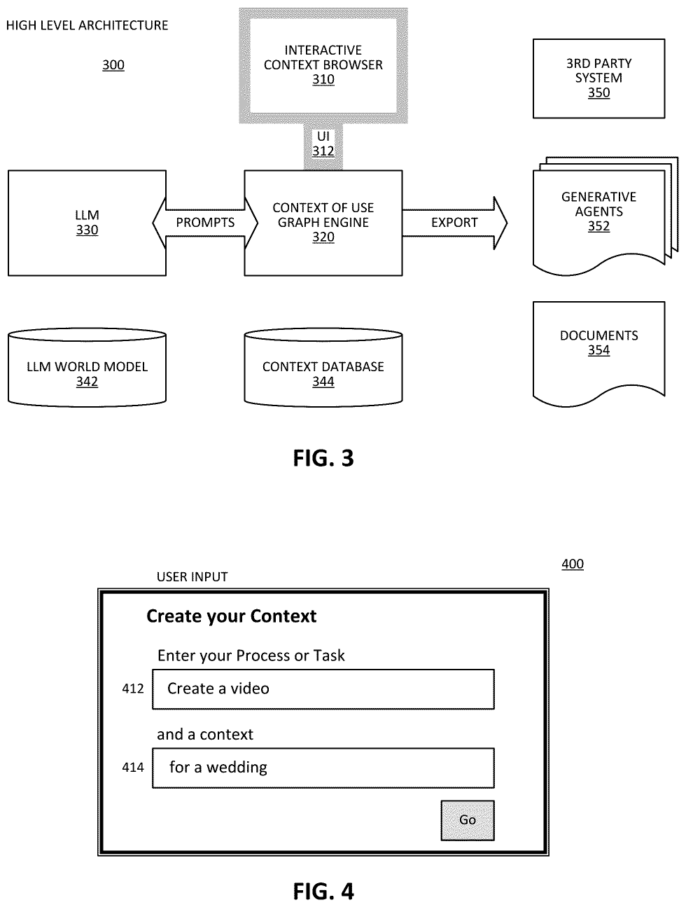

FIG. 3 is a block diagram of an example of a system to generate a context of use model. System 300 illustrates a high level architecture of a context graph generation system in accordance with an example of system 102 or system 104.

System 300 includes context of use graph engine 320, which represents a generative context graph automation engine (“CG engine”). In one example, context of use graph engine 320 accesses context database 344 to determine an ontology for a user query. In one example, context database 344 is part of context of use graph engine 320, enabling the engine to determine an ontology for a user query.

Context of use graph engine 320 queries LLM 330, which represents an LLM system. LLM 330 provides access to LLM world model 342. In one example, LLM 330 represents an NLP LLM system. In one example, LLM 330 represents a custom data model. In one example, LLM 330 represents one or more public-facing LLMs. The queries generated by context of use graph engine 320 are represented by the prompts, which result in responses from LLM 330 to the graphing engine.

In one example, context of use graph engine 320 generates interactive context browser 310 to interact with a user. The user can generate a query through UI (user interface) 312 to interactive context browser 310. In one example, interactive context browser 310 provides access to context of use graph engine 320 as an SaaS (software-as-a-service) provider. In one example, context of use graph engine 320 provides one or more interactive reports to the user through UI 312.

In one example, context of use graph engine 320 exports reports based on the accumulated knowledge data obtained through building a context graph through iterative querying of LLM 330. The system can stop the iterative repeating based on reaching one or more boundary conditions. The boundary conditions can be a certain number of tasks, finding all leaf nodes, or a user-defined boundary. The user-defined boundary can include looking for specific phases, specific stakeholders, or other condition. Generative agents 352 represent program code execution of agents that can analyze, organize, and present visualizations of the data.

In one example, generative agents 352 provide data to 3rd party system 350, which represents one or more systems not part of context of use graph engine 320. In one example, generative agents 352 provide the context graph data for use by the 3rd party system. In one example, generative agents 352 generate documents 354, which represent reports for organizing and/or for displaying the data.

System 300 leverages the potential of LLMs of serving as a proxy for actual field research. LLM 330 provides access to LLM world model 342 as a source for generating various forms of user requirements artifacts including user stories. Context of use graph engine 320 automates the modeling of a context-of-use related to a product of interest as a knowledge graph.

Context of use graph engine 320 serves as an automation agent which expands on a simple user input and generates content for a specified context without further user intervention. Context of use graph engine 320 can dynamically use the output from LLM models to create new semantic anchors in the context model. Thus, building the graph by generating the nodes of the knowledge graph that represents the model of the process or activity can also provide semantic anchors based on the ontology. The engine then uses the anchors to generate new prompts dynamically contextualized by the already stored context in the context graph. Such a process of model building creates auto-generation of a context of use description based on minimal user input and effort.

In one example, context of use graph engine 320 augments user research by serving as an alternative user interface to support co-authoring of a context graph via the interactive exploration and refinement of the generated graph. After generating the context graph, in one example, system 300 enables a user, via UI 312, to refine or further query based on information provided. In one example, the user can define one or more constraints, which the system can apply to reduce or focus the output. In one example, the user can set a new initial context.

System 300 can serve as a generative agent that generates requirements and user stories statements derived from the core context description. Automatic generation of requirements and user stories statements transforms factual information about the context of use into the user requirements.

In one example, system 300 can feed generative agents 352 (e.g., systems/subsystems) with output of context of the use graph engine 320. The output from the context graph can be exported to other 3rd party systems 350, can feed other generative agents to create graphical requirement models, or serve as a structured data source for generating documents (354) and deriving requirements in an algorithmic way by transforming the elements of context descriptions into tokens of requirements statements. The requirements statements can include user group (e.g., stakeholder) statements, task requirement statements, task object requirement statements for specific tasks, resource requirements statements for necessary resources for the tasks, or other requirements statements.

In one example, system 300 generates user stories. The user stories can include statements about what system operation has to be implemented in order to serve a user need. Examples of user stories can include: “As a [user group] I want to have [resource] available to perform [task],” or “As a [user group] I want to [specific action] with the help of the system to perform [task].” Statements such as these can be rephrased as requirements statements which serve as a basis for validation if a design meets all requirements or meets regulatory requirements.

In one example, system 300 generates user requirements. The user requirements can include statements about what the user will be able to do. Example of user requirements can include: “With the system, the user shall be able to access [resource],” or “With the system, the user shall be able to [action].” User requirements can indicate what the user needs from the system to accomplish their goals.

Automation of generating the context graph can include automation capability of generating a detailed list of formal requirements statements or user stories based on a simple task description. User stories are widely used in an industry that applies agile development or formal requirements management. Thus, system 300 can automate a useful tool with minimal user input.

In one implementation, automated generation can proceed as follows. In one example, the user of the generative CG engine first enters a task and task context. The system uses the task as an anchor for the generated context of use. The user can optionally input the title of a user group as an anchor for the generated content. The CG engine can next generate an entire context graph as described herein. In one example, the system includes one or more generative agents that can process the context graph content. In one example, the system includes a user story agent that derives user stories statements from all tasks in the context graph by extracting tokens. The user can then select the desired portion within the task hierarchy and export the list of user stories for use in another system.

In one example, system 300 persists generated context graphs for a user or group of users. Thus, system 300 can serve as corporate memory for larger clients or consulting firms. By calculating semantic similarities using existing LLM methods (e.g., embedding), in one example, context of use graph engine 320 can identify similar contexts and notify the user or the company about the potential redundancy or synergy.

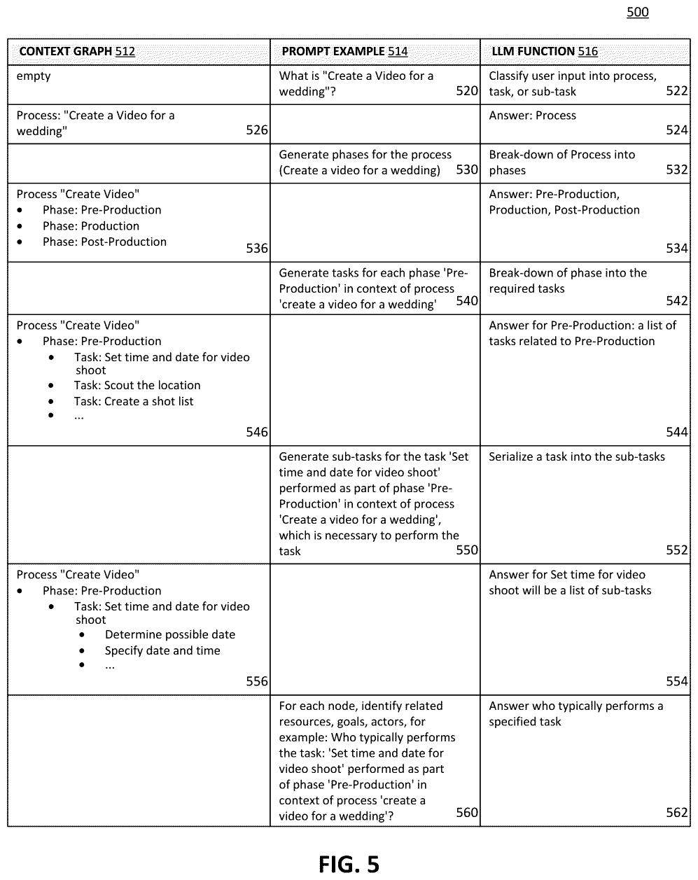

FIG. 4 is a diagram of an example of a user interface. UI 400 represents a user interface or a portion of a user interface to present to a user for submitting a user prompt to generate a context graph. UI 400 represents a UI that can be used in an example of system 102, system 104, or system 300.

In one example, UI 400 specifically represents initial user input. In one example, UI 400 includes field 412, which provides a space for the user to enter a process or task description in natural language. In one example, UI 400 includes field 414, which provides a space for the user to add a context as a qualifier for the query.

A user can use UI 400 or a similar UI for the system to set the leading context to auto-generate a context graph through dynamically system-generated prompts. In one example, the context graph is a predefined entity relationship graph that models the entities and relationships of a context of use (e.g., user, process, task, sub-task, resources). The graph model is generative in the sense that it can interact with the LLM to auto-generate itself with minimal initial input. In one example, the following user input may lead to a complete representation of the context of use. For example, if the user inputs the Task: “Create a video” in the Context: “for a wedding”, the system has a leading context to research and will gather information specifically related to the context provided.

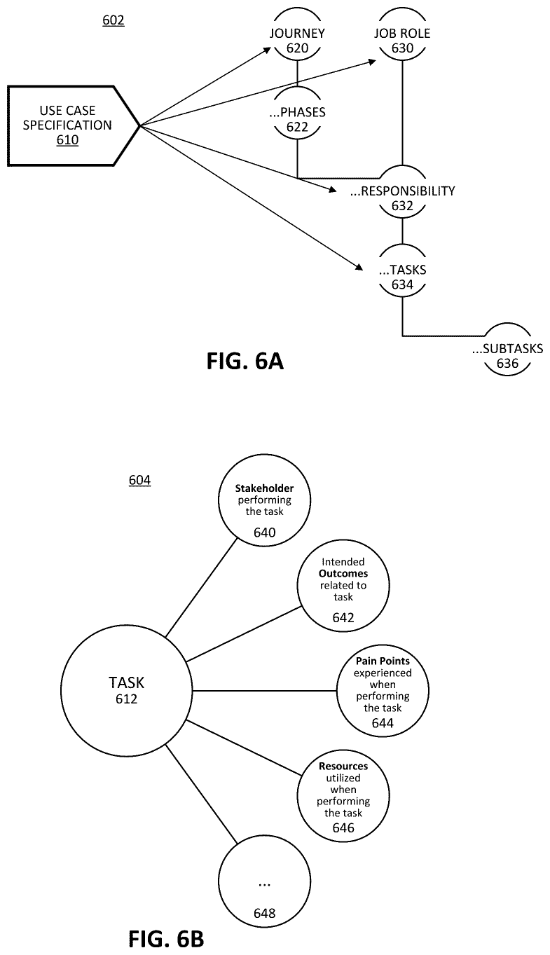

FIG. 5 is a diagram of an example of a dynamic prompt pipeline 514 which generates context graph 512 by generated dynamic prompts 514 for LLM system 516. Graph 500 represents a graph output in accordance with an example of system 102, system 104, or system 300. Graph 500 can represent the process and output in response to a query in UI 400.

Graph 500 illustrates how an output context graph is incrementally built up. The context graph auto generation process occurs with minimal input by iteratively inquiring an LLM system, parsing the results, and building out the model while determining the next query to send. The system begins with a process/phase/task/sub-task hierarchy, and can then enrich each node with metadata, such as actors, resources, goals, and so forth. The process not only automates the prompts to build up a hierarchy of entities, but also uses the already generated parent context of a node to optimize the subsequent prompts for the LLM system.

Graph 500 includes the columns: context graph 512, prompt example 514, and LLM function 516. The graph is read from the prompt to the LLM function and answer, then to the context graph population, to a subsequent prompt.

The user can provide a short natural language phrase input depicting a process, task, or a job title. Prompt example 520 represents an initial user input as “What is ‘Create a Video for a wedding’?” When the user submits this input, the CG engine can map the text input to the following concepts: model type (e.g., process, journey, task); context (e.g., a user qualifying statement); point of view (e.g., user group, role); and, targeted solution. In one example, the CG engine uses the given process or task as the anchor to hierarchically expand the task hierarchy and model the entire task spectrum and related elements of the given context of use.

Graph 500 illustrates LLM function 522 in response to the user input, which is to classify the user input into a process, task, or sub-task. The LLM returns a response that the answer to the classification is a process, as illustrated by LLM function 524. In response to determining the classification from an initial query to the LLM system, the CG engine can generate a context graph with a primary node of context graph 526 as Process: “Create a Video for a wedding”.

The CG engine generates a subsequent query identified by prompt example 530 as “Generate phases for the process.” LLM function 532 illustrates that the LLM breaks down the process into phases. LLM function 534 illustrates the LLM system providing the answer with phases “Pre-production, production, and post-production.” With the information from the response, the CG engine can add corresponding phases as sub-nodes to the primary node as illustrated at context graph 536.

The CG engine generates a subsequent query identified by prompt example 540 as “Generate tasks for ‘Pre-production’.” LLM function 542 illustrates that the LLM breaks down the phase into required tasks. LLM function 544 illustrates the LLM system providing the answer with a list of tasks related to pre-production. With the information from the response, the CG engine can add corresponding tasks as sub-nodes to the phase as illustrated at context graph 546.

The CG engine generates a subsequent query identified by prompt example 550 as “Generate sub-tasks for [the first identified task].” LLM function 552 illustrates that the LLM serializes the task into sub-tasks. LLM function 554 illustrates the LLM system providing the answer with a list of sub-tasks related to the “Set time” task. With the information from the response, the CG engine can add corresponding tasks as sub-tasks to the task as illustrated at context graph 556.

The CG engine generates subsequent queries identified by prompt example 560 as identifying actors. LLM function 562 illustrates that the LLM identifies the actors and provides a response to the query. With the information from the response, the CG engine can add corresponding information or metadata to the context graph, which is not specifically illustrated in graph 500.

It will be understood that the process can continue to iterate until boundary conditions are met. In one example, the boundary conditions are defined by the ontology. In one example, one or more boundary conditions are defined by the context provided by the user.

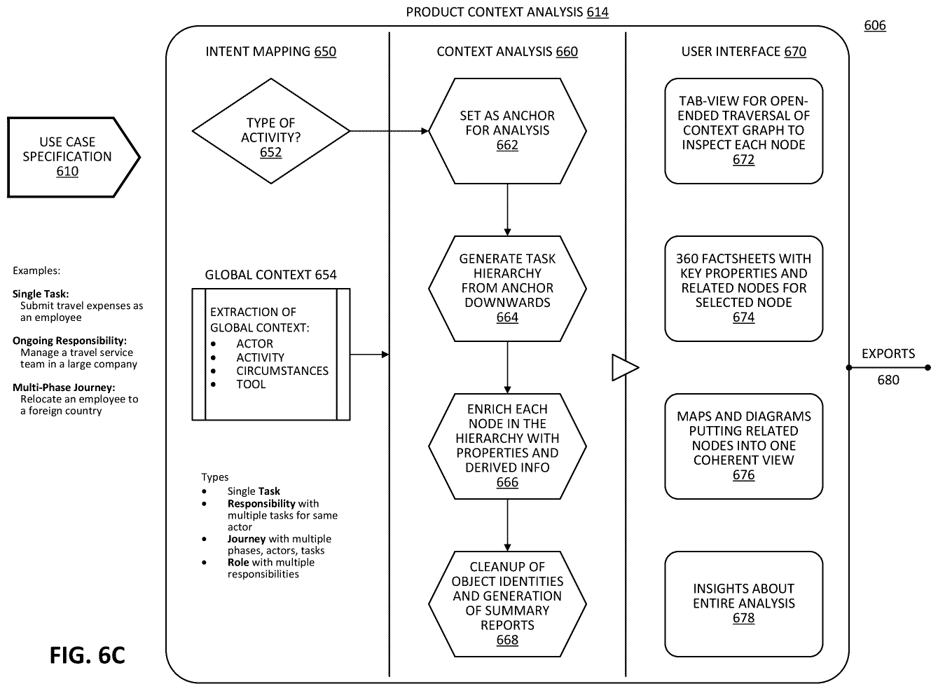

FIG. 6A is a block diagram of an example of mapping a use case specification entered by the user to a leading context within an ontology. Diagram 602 represents a context graph model in accordance with an example of model 200. Diagram 602 can be an ontological model in accordance with an example of graph 500.

Diagram 602 illustrates how a use case specification 610, which is based on the user input query, is mapped to a leading anchor within an ontology which can be built out as a hierarchical model. In one example, the anchor can be journey 620, in which case the context of use would be generate starting from a journey and and continue to with phases 622, which represent the different portions of the journey.

In another example, the user input is mapped to job role 630 which then serves as a starting point to generate a context graph including related responsibility 632 and tasks 634.

Responsibility 632 can have multiple tasks 634 associated with them. Tasks 634 represent the operations that need to be performed to accomplish the outcomes of journey 620. Subtasks 636 represent subdivisions of tasks 634.

Diagram 602 illustrates how a specific use case specification maps to a leading context in a task or job hierarchy. Using this hierarchy, the CG engine is generating the graph from the top down to build the hierarchy. Subtasks 636 are representing the boundary condition for breaking down a given context anchor into more details.

In one example, the CG engine extracts context of use descriptions from an interview transcript of a remote user interview and maps it to the context graph model. The graph can auto-fill missing information and enrich existing information with more details than obtained in the original interview.

FIG. 6B is a block diagram of an example of how the CG engine enriches nodes within the context graph with metadata. Diagram 604 illustrates how task 612 within the hierarchical structure of diagram 602 is enriched with meta information. Task 612 provides a specific example of tasks 634 of diagram 602.

In one example, task 612 is associated with stakeholder 640, outcomes 642, pain points 644, resources 646, and other objects 648. Stakeholder 640 represents the individual performing the task. Outcomes 642 represent the intended results related to the task. Pain points 644 represent the difficulties experienced when performing the task, referring to what might be an obstacle to, or what might prevent, the task from being completed. Resources 646 represent what might be utilized when performing the task. Other objects 648 represent other relationships/associations not specifically illustrated in diagram 604.

FIG. 6C is a block diagram of an example of an end-to-end product context analysis workflow. Diagram 606 represents a product context analysis in accordance with an example of diagram 602. Diagram 606 represents an analysis in with an example of system 102, or system 104, or system 300.

Diagram 606 illustrates use case specification 610, which is based on the user input query. Examples of the user input query can include, without limitation: a single task, an ongoing responsibility, a multiphase journey, or a job role. A single task can be something such as submitting a travel expense as an employee or creating a project completion report. An ongoing responsibility can be something such as managing a travel service team in a large organization or project management. A multiphase journey can be something such as relocating an employee to a foreign country or taking the lead on a new project. A job role can be something such as a Cashflow Manager.

Diagram 606 illustrates use case specification 610 as an input to product context analysis 614. In one example, product context analysis 614 includes intent mapping 650, context analysis 660, and UI (user interface) 670. In one example, the system provides interactive co-authoring by users. The interaction by the user can include opening one or more graphs or opening reports based on the context graph. The interaction can include traversing the data through different mappings of the data. In one example, the interaction includes the user editing the graph contents.

In one example, when the system generates the context graph, the system can make the inquired data persistent outside of the LLM system. Persisting the data outside the LLM system enables a user to interactively explore the entire context of use. Additionally, in one example, the system allows the user to control which parts of the overall context of use is generated. The system can provide a UI that displays the generated context graph at a specific position within the hierarchy, as selected by and explored by the user.

In one example, intent mapping 650 includes determination 652, to determine what type of activity is presented by use case specification 610. In one example, intent mapping 650 can include extraction of global context 654. The global context can include determining the actor, activity, circumstances, and tools for the activity type. The types can include a single task or a journey with phases, actors, and tasks. The types can include responsibility information with multiple tasks identified for the same actor. The types can include a role with multiple responsibilities for an actor.

With the input of determination 652 and global context 654, the context analysis 660 performs context graph generation. In one example, determination 652 provides the type of activity to context analysis 660, which sets the activity type as an anchor for analysis, block 662. The anchor for analysis refers to the primary node of the context graph from where the generation starts.

In one example, context analysis 660 can generate a task hierarchy from the anchor downwards, block 664. In one example, the analysis enriches each node in the hierarchy with properties and derived information, block 666. In one example, the analysis performs cleanup of object identities and generation of summary reports, block 668. Context analysis 660 can be informed by extraction of global conteXt 654.

Context analysis 660 can control node generation. In one example, to reduce the costs of querying the LLM system, context analysis 660 only builds the task hierarchy on demand if the user is drilling down, or if explicitly the generation of all nodes is activated. In one example, the user can initiate the generation of all nodes below a current location in the hierarchy. In one example, the user can initiate the generation of all nodes of the entire context model defined by the top node input by users or extracted from external documents.

In one example, context analysis 660 generates a data-driven user interface (UI) 670 which enables interactive, open-ended exploration of the content by the user. In one example, the user can drill down into each node and see children of that node and properties of that node. In one example, the user can use breadcrumbs to navigate up. The interaction by the user can occur while the system maintains a linkage between derived requirement models represented by the stored data, and the entities (e.g., stakeholders) in the context graph.

The interactive exploration UI allows users to inspect the quality and alignment of the graph information with the context which they were looking for. Users may miss information or disagree with information extracted from the LLM system. To empower users to influence the context model, in one example, UI 670 allows users to influence the outcome, by operations such as: modifying the text of a node, deleting a node (e.g., phase or task) to reduce the scope of the branch below, adding a node to expand the scope of the branch below, rephrasing the initial input and reviewing the impact of the rephrasing on the generated context, or other operations.

In one example, while exploring and reviewing the quality of a context graph, the user can, at any time, refine the root of the context graph which is the leading context provided by the initial user input. Refining the leading context can include navigating back to the root and changing the input phrase. Refining the leading context can include starting a new context analysis from a selected node in the graph.

For example, the user may inspect the output of the analysis and decide to start a new analysis with a selected entity. For example, start a new analysis for an identified stakeholder to generate a job role analysis specific for a selected stakeholder. The new context analysis can trigger the CG engine to generate all related responsibilities, tasks, and subtasks for a specific job role.

In one example, product context analysis 614 generates exports 680. Exports 680 represent outputs of the graph generation that can be shared or provided to another system or other program code.

The context graph generated by product context analysis 614 can be considered as structured raw information about the context of use for use case specification 610. Presenting the context graph in UI 670 can enable interactively exploring and controlling the generation of the context model by the user. For real world applications, in one example, the system can transform the structured raw information into industry standard documents familiar to stakeholders such as designers, product managers, developers, and so forth.

In one example, the transformation of the context graph information can be a simple transformation of the context graph. In one example, the system can organize the same content as overview lists to help develop the understanding and scope of the context. Lists can include: a list of all stakeholders, a list of all pain points, a list of all task objects, or other list.

In one example, the organizational transformation of the content can include 360-degree views. “360 views” can provide full a full perspective of each stakeholder, for example, listing all related tasks, goals, and pain points associated with each stakeholder. The view can include presenting for each task object list all related tasks and stakeholders who interact with it.

While 360 views for stakeholders can provide information for the actors, the lists can relate to product opportunities. For example, the system can present a list of all goals and how the context information relates to the goals, a list of all pain points to identify areas the organization can address, a list of desired outcomes, or other list.

In one example, the system can derive requirements statements from the context graph information. Such requirements statements can include reports such as: user needs statements, user requirements statements, user stories statements, or other report.

Diagram 606 illustrates different views on the context graph with UI 670. In one example, UI 670 can include tab view 672, factsheet view 674, map view 676, and insight view 678. Tab view 672 can provide a tab view for open-ended traversal of the context graph for inspection by the user of each node. Factsheet view 674 can provide 360 factsheets with key properties and related nodes for a selected node. Map view 676 can provide maps and diagrams that put related nodes into one coherent view. Insights view 678 can present insights about the entire analysis.

In addition to what is explicitly shown, UI 670 can present data in accordance with other established document templates. Simply rearranging the content of the context graph as overview lists can help product teams establish a detailed understanding of the scope of the context of use targeted for designing a product. A 360 view for one stakeholder can list all related tasks, goals, pain points, and so forth. A journey map can list stakeholders, tasks, and pain points for each phase of the journey. The journey map can map out different journey types, such as a process journey, a task lifecycle journey, a service journey, a user journey, or other sequential operation.

In one example, UI 670 can present an object map, which can be an object diagram indicating relationships, such as between actor and action (e.g., SeeMe models). In one example, UI 670 can present a workflow diagram to represent a task flow with different actors and task objects. In one example, UI 670 can present a storytelling view. Storytelling is based on the context graph topology and the metadata stored on each of the nodes, allowing the system to feed generative agents to produce a narrative description of a typical flow based on the tasks identified in the context of use description.

In one example, UI 670 can present scenarios of use. Scenarios of use can include narrative scenarios and modeled scenarios. A narrative scenario illustrates how a specific user performs a selected task. A model-like scenario in tabular form shows sub-tasks, intended interaction with the system, and user requirements.

In one example, UI 670 can present wireframes, which provide a high-level design illustrating how a screen could look like based on the identified user requirements for a selected sub-task. In one example, UI 670 can present storyboards. Storyboards can provide a multi-frame drawing of how a user uses and interacts with a system to get a job done. Storyboards can be an animation (animated video) of the sequence of frames.

In one example, the graph generated by context analysis 660 can be stored in a host system. The host system can provide views on the graph content at a later time with UI 670, pulling up stored content. Thus, in one example, the system of diagram 606 persists context graphs.

The capability of persisting a context graph during a user session enables interactive exploration and inspection without the required use of LLM systems. In addition, the system can persist context graphs beyond the session and make them accessible for later use outside of a LLM system. By computing the semantic space as an embedding, the system can generate repositories with searchable context of use instances that can be leveraged to manage and organize efforts related to context of use analysis.

In one example, the system reuses context graphs. In such a scenario, users log into their accounts and retrieve an existing context analysis to continue to inspect and optimize the graph, to generate requirements documents, or perform other interactions with the context graph information, including repeating prior interactions.

In one example, persisting the graphs enables comparing context graphs. In one example, the system calculates embeddings for each context graph. By calculating embeddings for each context graph, the system can generate a repository of context of use analysis data which can be searched and compared for similarity. The comparison capability allows organizations/companies to reduce redundancy and avoid disconnected attempts of understanding the same context of use.

For example, if the system detects that a user is defining an overlapping input phrase, the system can alert the user. Thus, for an input phrase (e.g., task, context, user group) to initiate the generation of a new context graph that overlaps an existing graph/analysis, the system can alert the user, or the organization the user belongs to, of the overlap to an already existing context graph stored under the same account.

In one example, the system enables users to merge related context graphs. If multiple context analyses relate to the same overarching context (e.g., sales, human resources, warehouse management), a company can decide to merge individual, but related context graphs, into one larger context representation.

In one example, the system enables what-if solution modeling with the context graph information present in their account. The “what-if” modeling can enable users to “simulate” the impact of a new design or solution. The user could select an existing analysis and describe the assumed solution (e.g., an intelligent robot, a drone, an intelligent personal assistant). With the additional information, the user can re-run the analysis, obtain new task flows from the system, and compare the new task flows with the old ones.

Returning to the earlier example of creating a video for a wedding, the following descriptions of diagram 700, diagram 800, diagram 900, diagram 1000, and diagram 1100 all refer to the same example. More specifically, diagram 700 illustrates an example of information related to a process overview for the user input “create a video for a wedding.” Diagram 800 illustrates an example of information related to a phase view for the different phases of “create a video for a wedding.” Diagram 900 illustrates an example of information related to a stakeholder list overview for different actors of “create a video for a wedding.” Diagram 1000 illustrates an example of information related to a list of user stories for different actors of “create a video for a wedding.” Diagram 1100 illustrates an example of information related to opportunities for different actors of “create a video for a wedding.”

The various diagrams illustrate outputs based on a query “create a video for a wedding.” The system can generate reports similar to what is illustrated. The various diagrams provide examples with detailed descriptions for each element. The description below is limited to identifying the elements rather than the specific details identified in the diagram. It will be understood that the details will vary by implementation, and are thus not limiting on the context graph generation described.

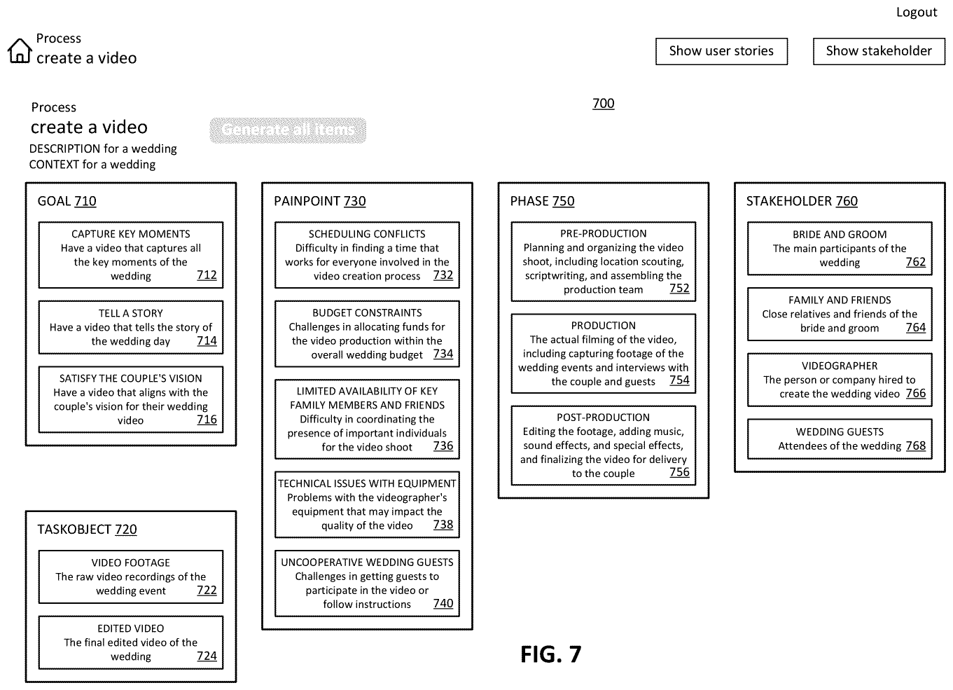

FIG. 7 is a block diagram of an example of a context graph browser. Diagram 700 illustrates an example of information related to the wedding video process. Diagram 700 identifies goal 710, TaskObject 720, PainPoint 730, phase 750, and stakeholder 760.

Goal 710 indicates reasons why for the video creation. The reasons can include capturing key moments, block 712, telling a story, block 714, and satisfying a couple's vision, block 716.

TaskObject 720 can indicate associated with the process. TaskObject 720 can include raw video footage, block 722, and edited video, block 724.

PainPoint 730 indicates challenges that could occur in performing the process. PainPoint 730 can provide the user with considerations when determining how to create the wedding video. As illustrated, the pain points can include scheduling conflicts, block 732, budget constraints, block 734, limited availability of key family members and friends, block 736, technical issues with equipment, block 738, and uncooperative wedding guests, block 740. A user can determine how to prepare to address these considerations.

Phase 750 indicates different phases to complete the process. The user can make plans based on the different phases. Phase 750 can include pre-production, block 752, production, block 754, and post-production, block 756.

Stakeholder 760 indicates various actors related to the wedding video creation. A user can explore the stakeholders to determine how to address the needs of the different individuals related to the process. Stakeholder 760 can include the couple (e.g., bride and groom), block 762, family and friends, block 764, videographer, block 766, and wedding guests, block 768.

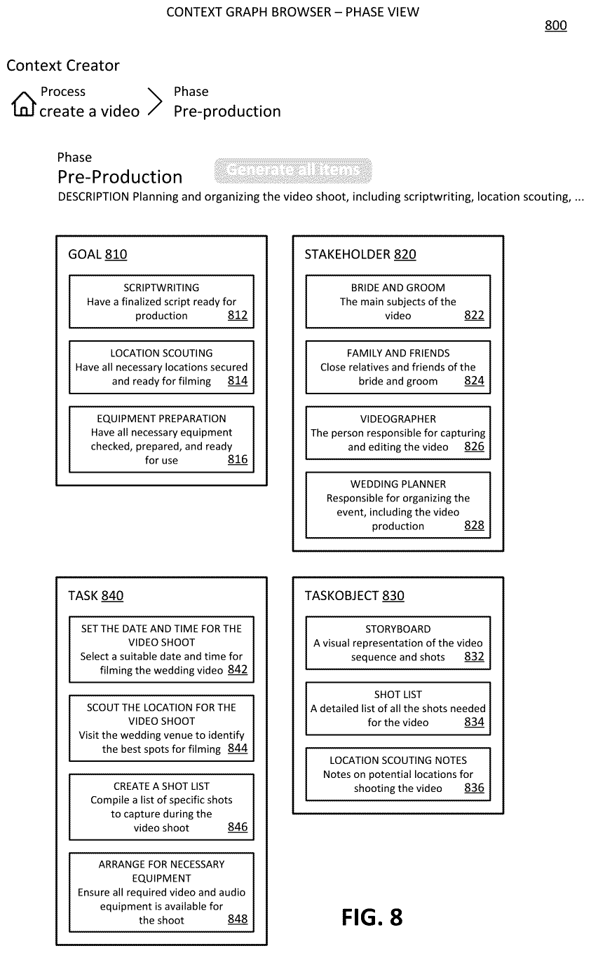

FIG. 8 is a block diagram of an example of a context graph browser context creator. Diagram 800 illustrates an example of information related to a phase view for the wedding video process. More specifically, diagram 800 illustrates information related to pre-production, where it will be understood that other phases are not specifically shown. The information in diagram 800 could be generated for different phases. Diagram 800 identifies goal 810, stakeholder 820, TaskObject 830, and task 840.

Goal 810 indicates reasons why pre-production can be performed. Goal 810 can specifically inform the user about preparation for pre-production. Goal 810 can include scriptwriting, block 812, location scouting, block 814, and equipment preparation, block 816.

Stakeholder 820 indicates various actors related to the pre-production for the wedding example provided. The couple is indicated as bride and groom, block 822. Other actors can include family and friends, block 824, videographer, block 826, and wedding planner, block 828.

TaskObject 830 can indicate items associated with pre-production. TaskObject 830 can include storyboard, block 832, a shot list, block 834, and location scouting notes, block 836.

Task 840 indicates various tasks to perform during the pre-production phase. Task 840 can include setting the data and time for the video shoot, block 842, scouting the location for the video shoot, block 844, creating a shot list, block 846, and arranging for necessary equipment, block 848. Diagram 800 does not indicate all tasks for the phase.

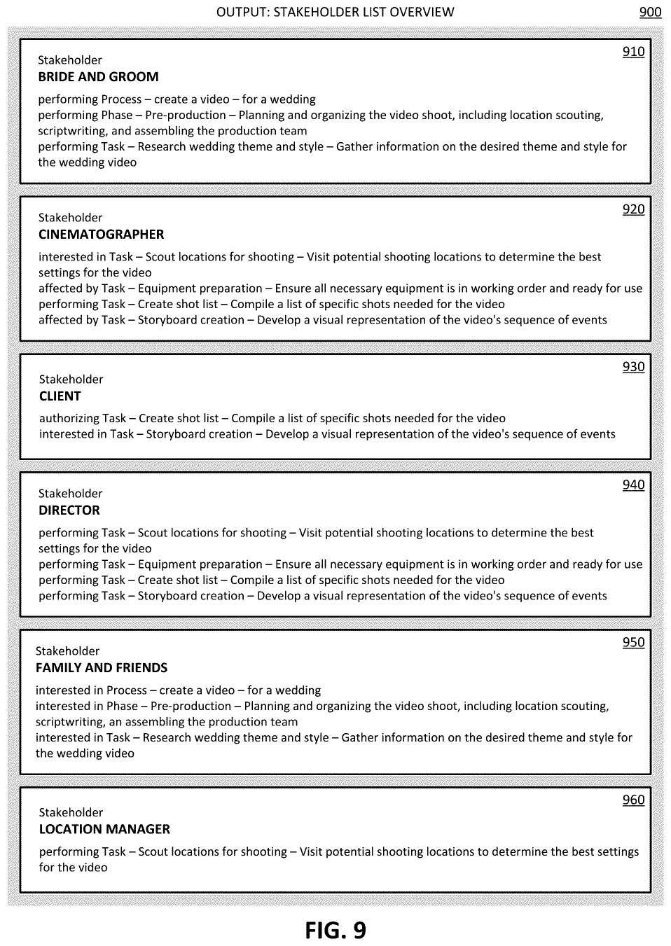

FIG. 9 is a block diagram of an example of a context graph browser stakeholder output list. Diagram 900 illustrates an example of information related to a stakeholder list overview for different actors associated with the wedding video process.

In one example, the stakeholders include bride and groom, block 910, cinematographer, block 920, client, block 930, director, block 940, family and friend, block 950, and location manager, block 960. It will be understood that diagram 900 does not present a complete list.

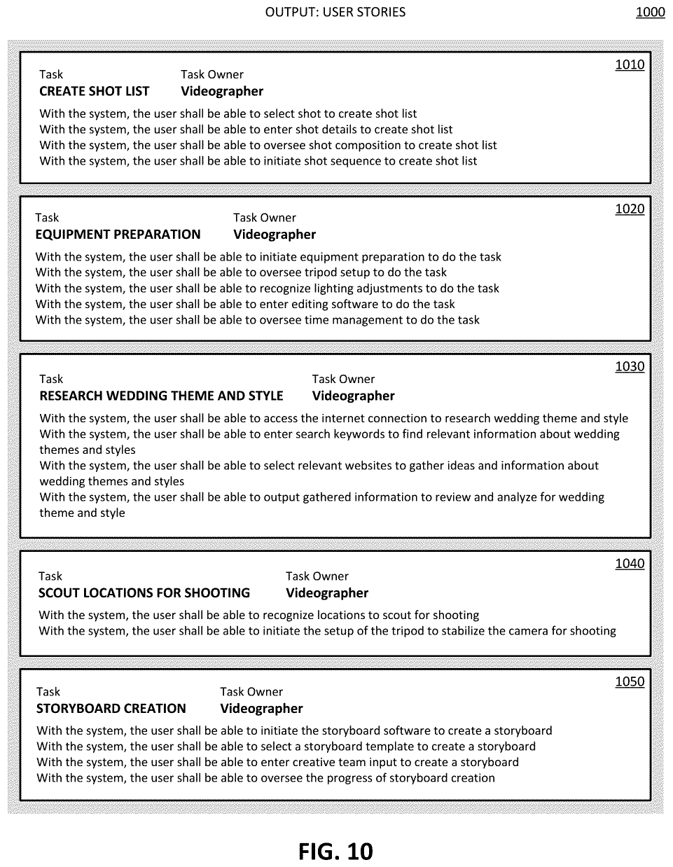

FIG. 10 is a block diagram of an example of a context graph browser user story output. Diagram 1000 illustrates an example of information related to a list of user stories for different actors associated with the wedding video process.

In one example, the user stories describe various user responsibilities for actors and their associated tasks. Diagram 1000 specifically describes responsibilities of the videographer. The system can generate other user stories for other stakeholders. The user stories can include creating a shot list, block 1010, performing equipment preparation, block 1020, researching the wedding theme and style, block 1030, scouting locations for shooting, block 1040, and storyboard creation, block 1050. It will be understood that diagram 1000 does not present a complete list.

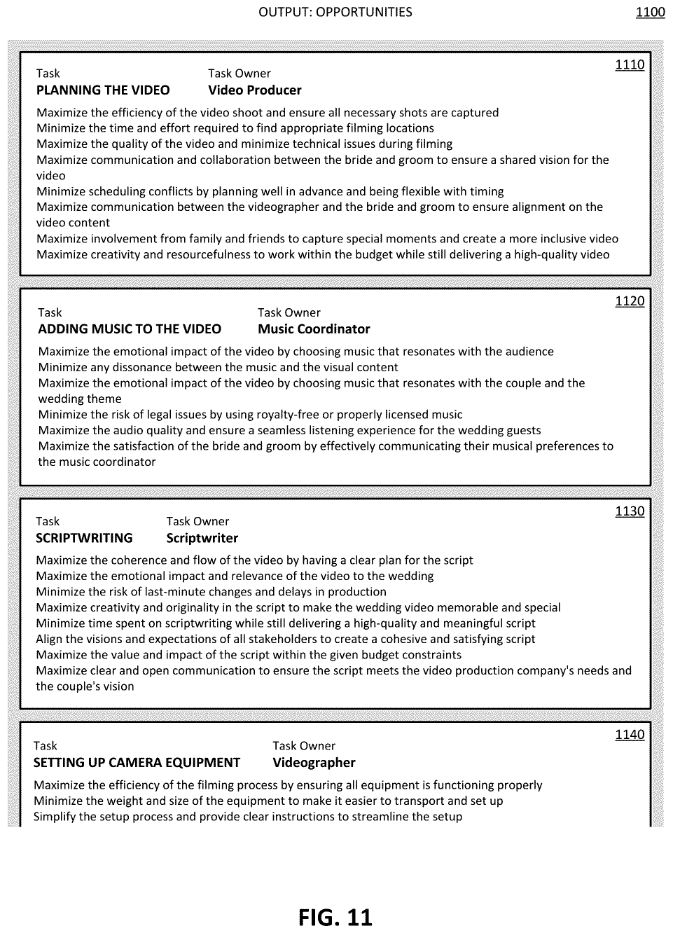

FIG. 11 is a block diagram of an example of a context graph browser opportunities output. Diagram 1100 illustrates an example of information related to opportunities for different actors associated with the wedding video process.

In one example, the user stories describe various opportunities for different actors. Diagram 1100 represents different opportunities for different actors, but it will be understood that certain actors can have more than one opportunity. The opportunities can include the video producer planning the video, block 1110, the music coordinator adding music to the video, block 1120, the scriptwriter writing the script, block 1130, and the videographer setting up camera equipment, block 1140. It will be understood that diagram 1100 does not present a complete list.

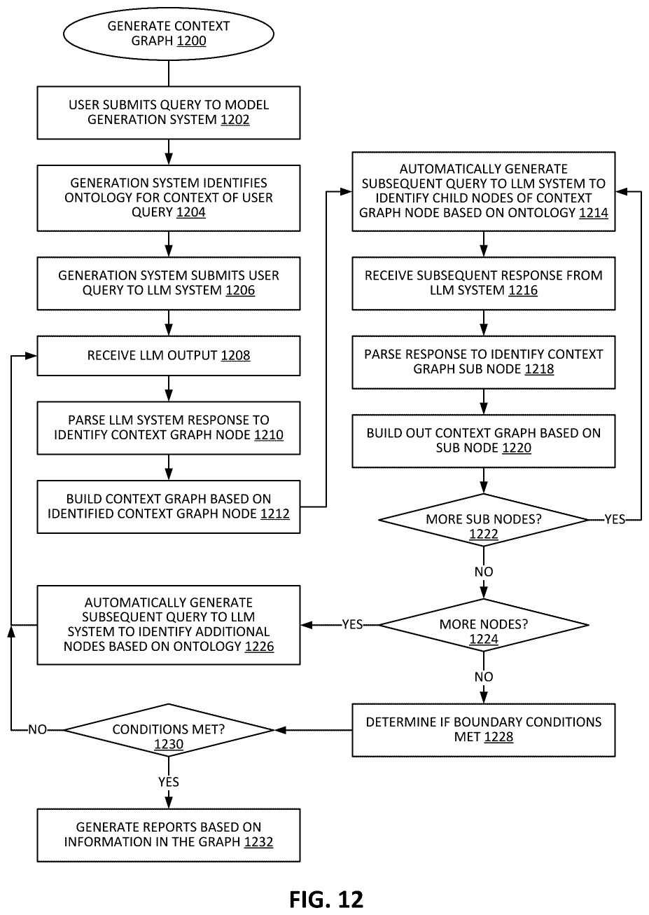

FIG. 12 is a flow diagram of an example of a process for generating a context graph. Process 1200 illustrates an example of automatically generating context graph content. Process 1200 can be executed by a context graph generation system, such as an example of system 102, system 104, or system 300.

A user submits a natural language query to a model generation system, block 1202. In one example, the generation system identifies an ontology for a context of the user query, block 1204. The generation system can submit the user query to an LLM system, block 1206. In one example, the generation system can submit the query to the LLM system to identify the ontology.

The generation system receives the LLM output, block 1208, and parses the response from the LLM system to automatically identify a context graph node from the response based on the ontology, block 1210. The system builds the context graph based on the context graph node, block 1212. In one example, the parsing of the response will identify more than one node. To the extent more than one node is identified, the system can populate the context graph with all nodes identified by the response.

The generation system can then automatically generate and submit a subsequent query to the LLM system based on the identified context graph node based on the ontology, block 1214. The generation system receives the subsequent response from the LLM system, block 1216, and parses the subsequent response to automatically identify a context graph sub-node based on the ontology, block 1218.

In one example, the generation system automatically builds out the context graph based on the context graph sub-node of the subsequent response, block 1220. In one example, the system iteratively repeats the automatic generation of child nodes of the context graph node.

The iterative building of the context graph is illustrated by the determination if there are more sub nodes. If there are more sub nodes, block 1222 YES branch, the system can continue to parse the response and build out the context. In one example, the building out of the child nodes includes submitting a subsequent query. In one example, the response will provide a response that indicates multiple sub nodes that the generation system can identify. If there are no more sub nodes, block 1222 NO branch, the system is finished building out the specific node.

In one example, the system can determine if there are more nodes to be built out. If there are more nodes to build out, block 1224 YES branch, in one example, the system can automatically generate a subsequent query to the LLM system to identify additional nodes based on the ontology, block 1226. In one example, the system can bypass block 1226 because it has already identified all the nodes. In one example, the system continues to query the LLM system to build out all nodes before building out any sub nodes. The system will then build out each node with its sub nodes, one node at a time.

The system can then return to repeat the receiving of the LLM output if it submitted a new query, or to parsing the LLM output if no more queries need to be submitted. In one example, the system continues to query, parse, and build out the context graph until boundary conditions are met. In one example, the system determines if the boundary conditions are met, block 1228.

If the boundary conditions are met, block 1230 YES branch, the system is finished building the graph, and can generate one or more reports based on the information in the graph, block 1232. The system can also store the context graph to persist it. If the boundary conditions are not met, block 1230 NO branch, the system can continue to iteratively repeat the querying, parsing, and building out until one or more boundary conditions have been met. In one example, building out the nodes includes generating metadata for each node. The metadata can include information such as user tasks, actors associated with the user tasks, responsibilities and skills needed, resources, or other information.

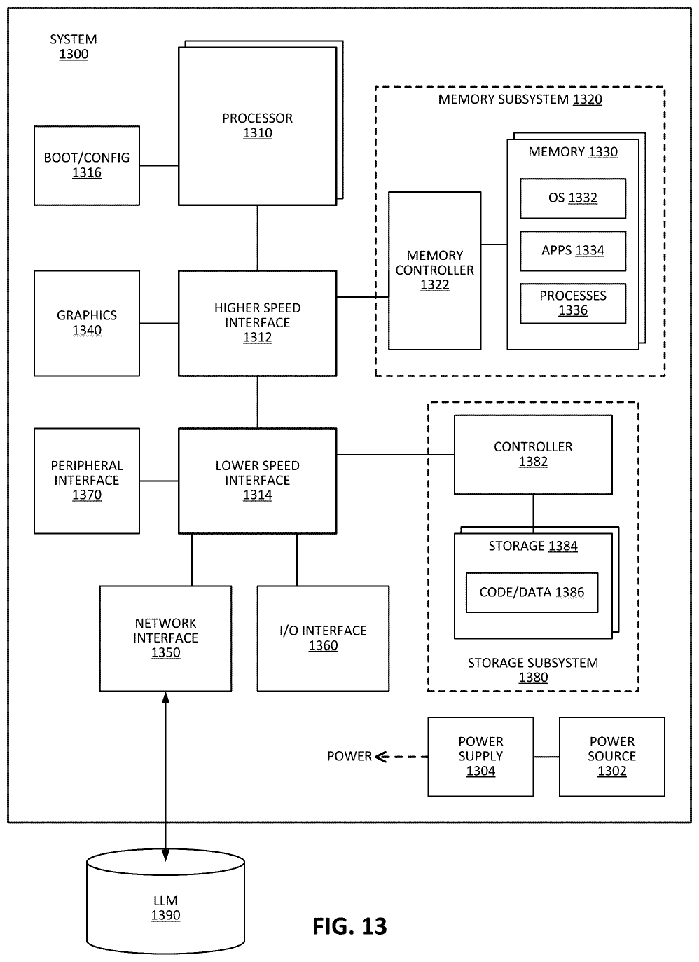

FIG. 13 is a block diagram of an example of a computing system in which context use modeling can be performed. System 1300 represents a computing device in accordance with any example herein, and can be a laptop computer, a desktop computer, a tablet computer, a server, a gaming or entertainment control system, embedded computing device, or other electronic device.

System 1300 represents a system to perform context graph generation in accordance with an example of system 102, system 104, system 300, or diagram 606. In one example, system 1300 represents one or more computer systems that receive input from a user. In one example, system 1300 represents one or more computer systems that execute on the back end in response to user input and operates as a software-as-a-service provider to generate the context graph. As an SaaS provider, the system can query LLM 1390 and process the content received from LLM 1390. In one example, system 1300 can store the context graph information in storage 1384. In one example, system 1300 can store the context graph information in memory 1330.

System 1300 includes processor 1310 can include any type of microprocessor, central processing unit (CPU), graphics processing unit (GPU), processing core, or other processing hardware, or a combination, to provide processing or execution of instructions for system 1300. Processor 1310 can be a host processor device. Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or a combination of such devices.

System 1300 includes boot/config 1316, which represents storage to store boot code (e.g., basic input/output system (BIOS)), configuration settings, security hardware (e.g., trusted platform module (TPM)), or other system level hardware that operates outside of a host OS. Boot/config 1316 can include a nonvolatile storage device, such as read-only memory (ROM), flash memory, or other memory devices.

In one example, system 1300 includes interface 1312 coupled to processor 1310, which can represent a higher speed interface or a high throughput interface for system components that need higher bandwidth connections, such as memory subsystem 1320 or graphics interface components 1340. Interface 1312 represents an interface circuit, which can be a standalone component or integrated onto a processor die. Interface 1312 can be integrated as a circuit onto the processor die or integrated as a component on a system on a chip. Where present, graphics interface 1340 interfaces to graphics components for providing a visual display to a user of system 1300. Graphics interface 1340 can be a standalone component or integrated onto the processor die or system on a chip. In one example, graphics interface 1340 can drive a high definition (HD) display or ultra high definition (UHD) display that provides an output to a user. In one example, the display can include a touchscreen display. In one example, graphics interface 1340 generates a display based on data stored in memory 1330 or based on operations executed by processor 1310 or both.

Memory subsystem 1320 represents the main memory of system 1300, and provides storage for code to be executed by processor 1310, or data values to be used in executing a routine. Memory subsystem 1320 can include one or more varieties of random-access memory (RAM) such as DRAM, 3DXP (three-dimensional crosspoint), or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310, such as integrated onto the processor die or a system on a chip.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1300 includes interface 1314, which can be coupled to interface 1312. Interface 1314 can be a lower speed interface than interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can exchange data with a remote device, which can include sending data stored in memory or receiving data to be stored in memory.

In one example, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, NAND, 3DXP, or optical based disks, or a combination. Storage 1384 holds code or instructions and data 1386 in a persistent state (i.e., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (i.e., the value or state of the data is indeterminate if power is interrupted to system 1300). In one example, storage subsystem 1380 includes controller 1382 to interface with storage 1384. In one example controller 1382 is a physical part of interface 1314 or processor 1310, or can include circuits or logic in both processor 1310 and interface 1314.

Power source 1302 provides power to the components of system 1300. More specifically, power source 1302 typically interfaces to one or multiple power supplies 1304 in system 1300 to provide power to the components of system 1300. In one example, power supply 1304 includes an AC to DC (alternating current to direct current) adapter to plug into a wall outlet. Such AC power can be renewable energy (e.g., solar power) power source 1302. In one example, power source 1302 includes a DC power source, such as an external AC to DC converter. In one example, power source 1302 or power supply 1304 includes wireless charging hardware to charge via proximity to a charging field. In one example, power source 1302 can include an internal battery or fuel cell source.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for generating a context graph, comprising:
submitting a user query to a large language model (LLM) system;
identifying an ontology for a context of the user query;
parsing a first response from the LLM system to automatically identify one or multiple context graph nodes from the first response based on the ontology;
automatically building a context graph with the one or multiple context graph nodes;
expanding the context graph by iteratively repeating until a boundary condition has been met:
automatically submitting a subsequent query to the LLM system based on the one or multiple context graph nodes to identify related nodes; and
building out the context graph based on a subsequent response to the subsequent query.

2. The method of claim 1, wherein iteratively repeating until the boundary condition has been met comprises stopping the repeating based on identifying related nodes that have no further related nodes.

3. The method of claim 1, wherein identifying the related nodes comprises identifying sub-nodes for one of the one or multiple context graph nodes.

4. The method of claim 1, wherein identifying the related nodes comprises identifying user tasks for the one or multiple context graph nodes.

5. The method of claim 4, wherein identifying the related nodes comprises identifying actors associated with the user tasks.

6. The method of claim 5, further comprising:
automatically generating a user task factsheet to identify responsibilities and skills needed to perform the user tasks.

7. The method of claim 1, further comprising:
storing the context graph as an interactive document for interaction with a user.

8. The method of claim 7, wherein the interaction with the user comprises opening, traversing, and editing by the user.

9. The method of claim 7, further comprising:
generating an interactive analytical view of the context graph; and
in response to selection by a user, automatically building out an analysis based on nodes and sub-nodes of the context graph.

10. The method of claim 7, further comprising:
generating one or more of requirements models, requirements statements, or insights reports from information in the stored context graph.

11. The method of claim 10, further comprising:
maintaining a linkage between derived requirement models and entities in the context graph during modification of the context graph.

12. A computer system for generating a context graph, comprising:
memory to store program code; and
one or more processors to execute the program code to execute a method including:
submitting a user query to a large language model (LLM) system;
identifying an ontology for a context of the user query;
parsing a first response from the LLM system to automatically identify a context graph node from the first response based on the ontology;
building the context graph based on the context graph node of the first response; and
iteratively repeating until a boundary condition has been met:
automatically submitting a subsequent query to the LLM system based on the identified context graph node;
parsing a subsequent response from the LLM system to automatically identify a context graph sub-node from the subsequent response based on the ontology; and
automatically building out the context graph based on the context graph sub-node of the subsequent response.

13. The computer system of claim 12, wherein the context graph node comprises a first context graph node, wherein the parsing the first response comprises automatically identifying the first context graph node and a second context graph node from the first response.

14. The computer system of claim 13, wherein the automatically submitting the subsequent query comprises automatically submitting a first subsequent query for the first context graph node and automatically submitting a second subsequent query for the second context graph node, wherein the parsing the subsequent response comprises automatically identifying sub-nodes for the first subsequent query and further comprising parsing another subsequent response to automatically identify sub-nodes for the second subsequent query.

15. The computer system of claim 12, wherein the context graph sub-node comprises a first context graph sub-node, wherein the parsing the subsequent response comprises automatically identifying the first context graph sub-node and a second context graph sub-node from the first response.

16. The computer system of claim 12, wherein iteratively repeating until the boundary condition has been met comprises stopping the repeating based on identifying sub-nodes of a node type that have no further child nodes.

17. The computer system of claim 12, wherein automatically building out the context graph comprises automatically generating user tasks for each sub-node.

18. The computer system of claim 17, wherein automatically building out the context graph comprises automatically identifying actors associated with the user tasks.

19. The computer system of claim 17, further comprising:
automatically generating a user task factsheet to identify responsibilities and skills needed to perform user tasks.

20. The computer system of claim 12, further comprising:
generating an interactive analytical view of the context graph; and
in response to selection by a user, automatically building out an analysis based on nodes and sub-nodes of the context graph.
